(19) United States
(12) Patent Application Publication
(10) Pub. No.: US 2014/0367981 A1
(43) Pub. Date: Dec. 18, 2014

(54) Bumper Beam Including a Tubular Aluminum Substrate Wrapped with Pre-Impregnated Carbon Fiber Fabric Layers

(71) Applicant: Ford Global Technologies, LLC, Dearborn, MI (US)

(72) Inventors: Matthew John Zaluzec, Canton, MI (US); Mohamed Ridha Baccouche, Ann Arbor, MI (US); Richard H. Wykoff, Commerce Township, MI (US); Saied Nusier, Canton, MI (US); Mohammed Omar Faruque, Ann Arbor, MI (US)

(21) Appl. No.: 13/919,272

(22) Filed: Jun. 17, 2013

(51) Int. Cl. B60R 19/03; B32B 38/08; B32B 37/00; B32B 37/12; B32B 37/14; B32B 37/16

(52) U.S. Cl. CPC B60R 19/03; B32B 37/142; B32B 37/16; B32B 37/0038; B32B 37/12; B32B 38/08; B60R 2019/1886
USPC 293/121; 29/897.2; 156/212

(57) ABSTRACT

A bumper beam includes an aluminum tubular carrier that is wrapped with a plurality of carbon fiber fabric layers. The carbon fiber fabric is pre-impregnated with a two-part epoxy resin system. The layers of carbon fiber fabric are applied in an alternating series with the carbon fibers in adjacent layers extending perpendicularly relative to the carbon fibers in adjacent layers.

### TECHNICAL FIELD

This disclosure relates to lightweight vehicle bumpers that have superior strength to weight properties.

### BACKGROUND

There is a substantial need to reduce vehicle weight to meet stringent fuel economy standards. Vehicle bumpers are relatively large parts that are relatively heavy due to the need to protect the vehicle and passengers during a collision.

This disclosure is directed to providing a solution to the above problem and other problems as summarized below.

### SUMMARY

According to one aspect of this disclosure, a bumper beam is provided for a vehicle that comprises a metal carrier, and a plurality of layers of carbon fiber fabric. The fabric is wrapped about the carrier and has carbon fibers extending in one direction. The fabric is pre-impregnated with a resin and a curing agent. The fabric is wrapped about the carrier with the fabric being arranged so that carbon fibers in alternating layers are oriented perpendicular to adjacent layers.

According to a further aspect of this disclosure, the carbon fibers in a first set of layers are oriented to extend in the longitudinal direction that is aligned with the length of the bumper beam. The carbon fibers in a second set of layers are oriented to extend in the transverse direction that is aligned with the vertical direction on a front wall and a back wall of the bumper and aligned with a longitudinal vehicle direction on a top wall and a bottom wall of the bumper beam.

According to other aspects of this disclosure, the metal carrier may be a rectangular cross-section aluminum tube. The aluminum tube may have a front wall, a rear wall, a top wall, and a bottom wall. A bracket for a crash can is secured to the rear wall of the tube and over the layers of fabric. The bracket may include an upper clamp and a lower clamp that clamp the layers of fabric to the top wall and the bottom wall, respectively.

The resin and curing agent are two parts of an epoxy bonding system. At least fifteen layers of carbon fiber fabric may be wrapped about the bumper beam. In another embodiment, the bumper beam may have between sixteen and twenty layers of carbon fiber fabric are wrapped about the bumper beam.

According to other aspect of this disclosure as it relates to a method of making a bumper beam, a method is disclosed for making a bumper beam. The method comprises selecting a metal carrier; and wrapping the carrier with a plurality of layers of carbon fiber fabric. The fabric may be coated with a resin. The layers include a first set of layers that include carbon fibers extending parallel to the length of the bumper beam and a second set of layers that include carbon fibers extending around the width and height of the bumper beam.

According to other optional aspects of this disclosure, the method may further comprise assembling the carrier with the plurality of layers of carbon fiber fabric to a crash can bracket. The aluminum tube may have a front wall, a rear wall, a top wall, and a bottom wall and wherein a bracket for a crash can is secured to the rear wall of the tube and over the layers of fabric. The bracket may include an upper clamp and a lower clamp that clamp the layers of fabric to the top wall and the bottom wall of the tube, respectively.

The resin and curing agent may be two parts of an epoxy bonding system. The method may include wrapping at least fifteen layers of carbon fiber fabric about the bumper beam. Alternatively, the bumper beam may have between sixteen and twenty layers of carbon fiber fabric are wrapped about the bumper beam. The method may further comprise a step of stacking a plurality of layers of the fabric with the fibers in adjacent layers being oriented perpendicularly relative to the adjacent layers that is performed before the step of wrapping the carrier.

The above aspects of this disclosure and other aspects will be described in greater detail below with reference to the attached drawings.

### BRIEF DESCRIPTION OF THE DRAWINGS

FIG. 1 is a fragmentary perspective view of part of a front end of a vehicle including a bumper beam made according to one aspect of this disclosure, crush cans, crush can brackets, and front rails.

FIG. 2 is a fragmentary perspective view of a bumper beam showing the carbon fiber reinforcement layers partially removed.

FIG. 3 is a schematic representation of a test fixture used to test a bumper bar.

FIG. 4 is a graph comparing the force of resistance over time for a boron bumper bar, and aluminum bumper bar, an aluminum bumper bar having 20 layers of carbon fiber fabric and aluminum bar having 16 layers of carbon fiber fabric.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

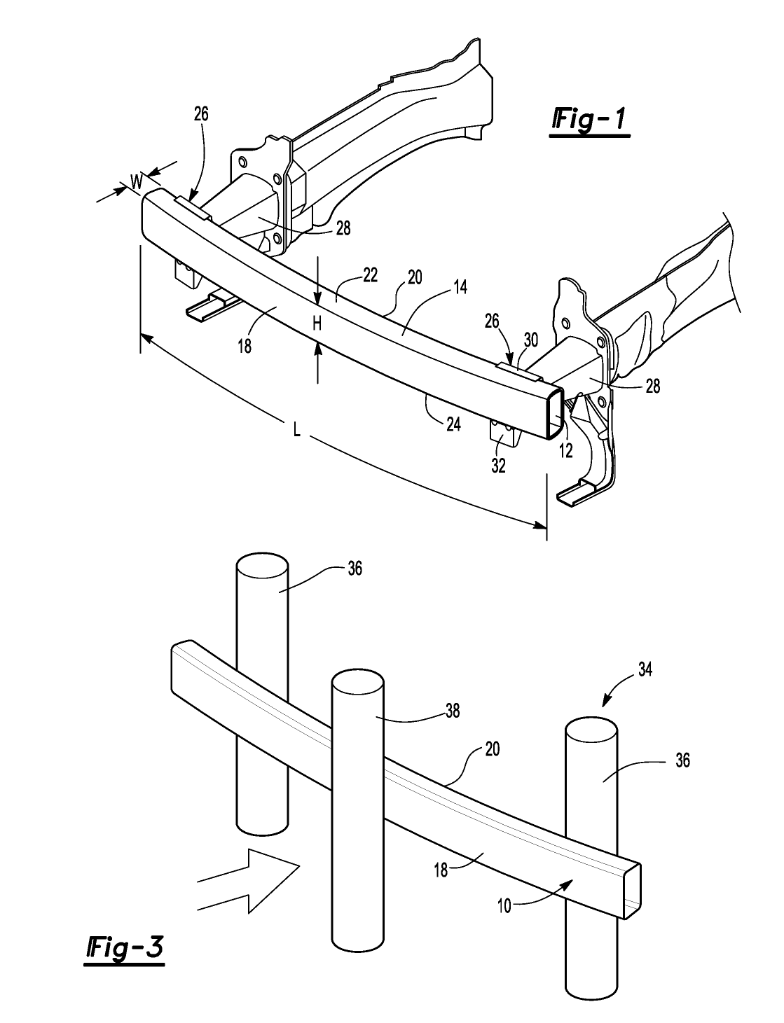

Referring to FIGS. 1 and 2, a bumper beam 10 for a vehicle includes a carrier 12 that is wrapped with a carbon fiber fabric 14. The carbon fiber fabric 14 includes a plurality of carbon fibers 16 (shown in FIG. 2) that are oriented in one direction. It should be understood that when the carbon fibers 16 are stated to extend in one direction, that the majority of the carbon fibers 16 in the carbon fiber fabric 14 extend in that one direction while some of the fibers may be oriented in another direction. The bumper beam 10 has a length L, a height H and a width W, that are indicated in FIGS. 1 and 2.

The carrier 12 includes a front wall 18 and a rear wall 20. A top wall 22 and bottom wall 24 extend between the front wall 18 and rear wall 20. The carrier 12 is attached by a bracket 26 that is assembled to a crash can 28. An upper clamping member 30 and a lower clamping member 32 are provided by the bracket 26 to retain the carrier 12 in position in front of the crash can 28.

The carbon fiber fabric 14 is pre-impregnated with a resin. The resin is preferably included as part of a two-part resin system such as an epoxy resin that includes a curing agent. Alternatively, other resin systems may be used to pre-impregnate the carbon fiber fabric 14, such as a resin that sets upon the application of heat.

With specific reference to FIG. 2, the bumper beam 10 is shown wrapped with a plurality of layers of carbon fiber fabric 14. The carbon fibers 16 in the outer layer extend in the direction L and the next layer includes carbon fibers 16 that are oriented in the height direction H. The carbon fiber fabric 14 is wrapped over the top wall 22 and bottom wall 24 with the carbon fibers extending in the width direction W. The number of layers of carbon fiber fabric 14 wrapped on the carrier 12 is determined by the desired strength of the bumper beam 10. At least fifteen layers of carbon fiber fabric should be wrapped around an extruded aluminum tube having a wall thickness of 1 mm to obtain the required strength.

In one example, sixteen plies of carbon fiber fabric 14 are wrapped about a carrier 12 that has aluminum walls having a thickness of 1 mm. The combined weight of the sixteen plies of carbon fiber fabric and the aluminum carrier is 2.541 kg.

As another example, twenty layers of carbon fiber fabric 14 are wrapped around a carrier 12 having aluminum walls with a thickness of 1 mm. The carrier 12 and twenty layers of carbon fiber fabric have a weight of 2.715 kg.

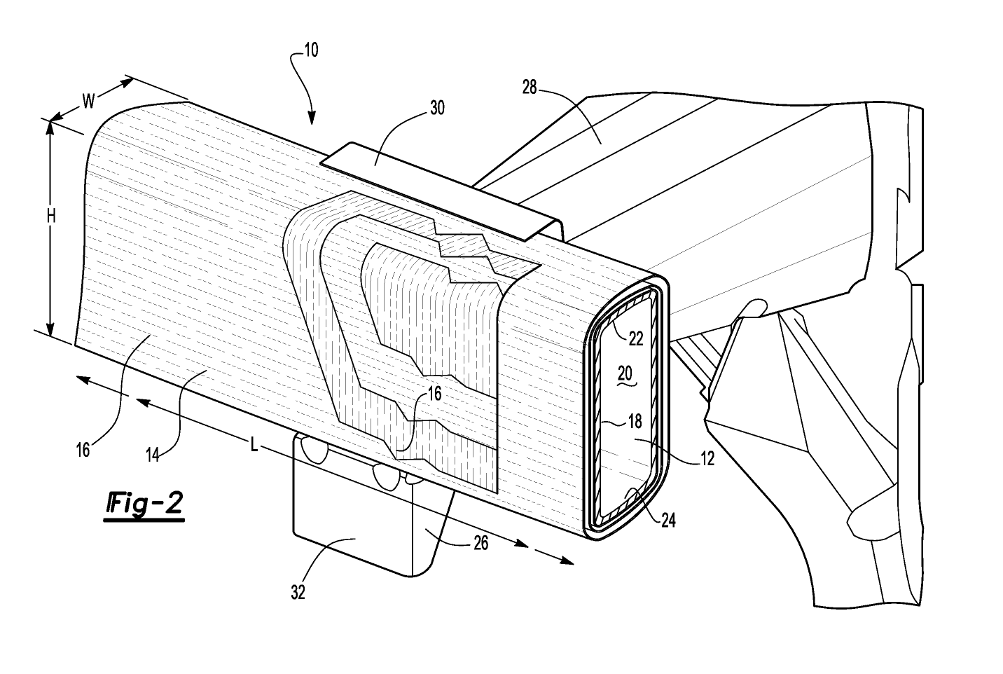

Referring to FIG. 3, a test fixture 34 that is used to test the strength of a bumper beam by evaluating the force absorbed over time by the bumper beam 10. The test fixture 34 includes a pair of backing posts 36 that are spaced apart a predetermined distance and engage the rear wall 20 of the bumper beam 10. An impact post 38 is driven into the bumper beam 10 at a central location relative to the backing post 36 in a direction shown by the arrow in FIG. 3. The impact post 38 engages the front wall 18 of the carrier 12 to apply a measured force to test the strength of the bumper beam 10.

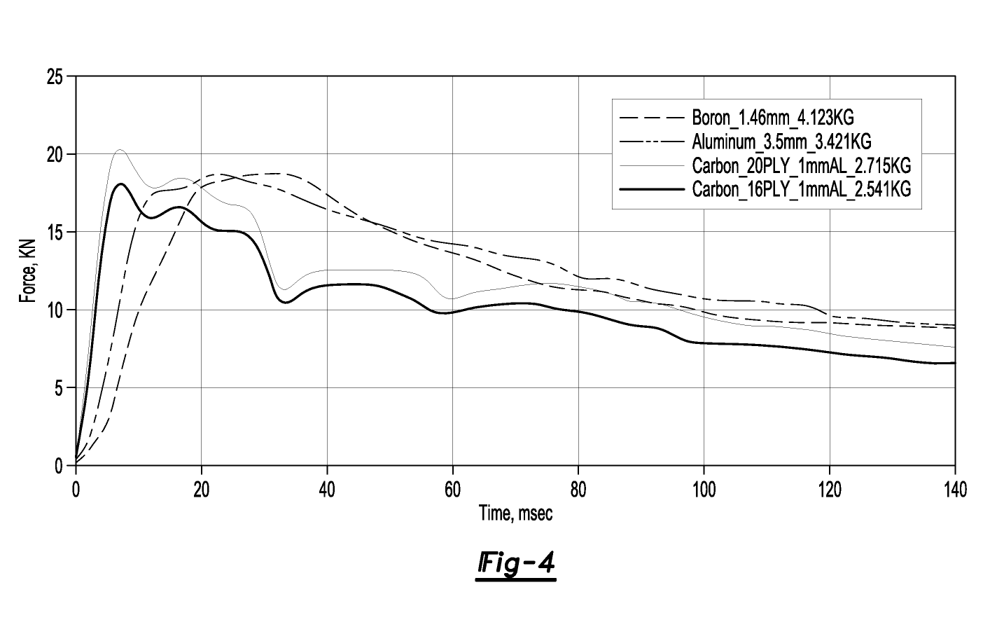

Referring to FIG. 4, a chart is provided that compares load test results for carbon fiber fabric wrapped bumper beams to bumper beams made of boron having a wall thickness of 1.46 mm and a weight of 4.123 kg and an aluminum bumper beam having a wall thickness of 3.5 mm and a weight of 3.421 kg. All of the bumper beam test results presented are considered to be acceptable in that they met the load bearing specifications for a vehicle bumper. The first example above of an aluminum carrier having aluminum walls with a thickness of 1 mm wrapped with sixteen plies of carbon fiber fabric had greater initial load carrying stiffness than either the aluminum or boron bumper beam. The overall strength of the sixteen ply wrapped bumper beam was comparable to the boron bumper beam and the extruded aluminum bumper beam and was within approximately 3 KN over the last half of the test.

The bumper beam 10 having an aluminum carrier with 1 mm thick walls that is wrapped with 20 plies of carbon fiber fabric 14 is shown by the graph to have slightly greater initial impact strength of more than 20 KN at approximately seven ms. The strength of the beam throughout the latter half of the test is nearly identical to the boron bumper beam and the aluminum bumper beam that were tested. The carbon fiber wrapped bumper beams show a 20 to 38% lighter weight compared to traditional boron steel and extruded aluminum bumper beams. The carbon fiber fabric wrapped bumper having twenty wraps achieves a weight savings of 1.4 kg, or 34% compared to a boron bumper beam. The carbon fiber fabric wrapped aluminum carrier having sixteen wraps achieves a weight savings of 1.582 kg, or a 38% weight savings compared to a boron bumper beam.

The weight savings compared to an extruded aluminum bumper is approximately a 20% weight savings compared to an aluminum carrier wrapped with 20 plies of carbon fiber fabric.

When compared to a carrier wrapped with 16 plies of carbon fiber fabric, the weight savings exceeded 25% compared to the extruded aluminum bumper.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A bumper beam for a vehicle comprising:
a metal carrier;
a plurality of layers of carbon fiber fabric having carbon fibers extending in one direction are wrapped about the carrier, wherein the fabric is pre-impregnated with a resin and a curing agent, and wherein the fabric is wrapped about the carrier with the fabric being arranged with the carbon fibers in alternating layers being oriented perpendicular to adjacent layers.

2. The bumper beam of claim 1 wherein the carbon fibers in a first set of layers are oriented to extend in the longitudinal direction that is aligned with the length of the bumper beam and the carbon fibers in a second set of layers are oriented to extend in the transverse direction that is aligned with the vertical direction on a front wall and a back wall of the bumper and aligned with a longitudinal vehicle direction on a top wall and a bottom wall of the bumper beam.

3. The bumper beam of claim 1 wherein the metal carrier is a rectangular cross-section aluminum tube.

4. The bumper beam of claim 3 wherein the aluminum tube has a front wall, a rear wall, a top wall, and a bottom wall and wherein a bracket for a crash can is secured to the rear wall of the tube and over the layers of fabric.

5. The bumper beam of claim 4 wherein the bracket includes an upper clamp and a lower clamp that clamp the layers of fabric to the top wall and the bottom wall, respectively.

6. The bumper beam of claim 1 wherein the resin and curing agent are two parts of an epoxy bonding system.

7. The bumper beam of claim 1 wherein at least fifteen layers of carbon fiber fabric are wrapped about the bumper beam.

8. The bumper beam of claim 1 wherein between sixteen and twenty layers of carbon fiber fabric are wrapped about the bumper beam.

9. A method of making a bumper beam comprising:
selecting a metal carrier;
wrapping the carrier with a plurality of layers of carbon fiber fabric that is coated with a resin, wherein the layers include a first set of layers that include carbon fibers extending parallel to the length of the bumper beam and a second set of layers that include carbon fibers extending around the width and height of the bumper beam.

10. The method of claim 9 further comprising:
assembling the carrier with the plurality of layers of carbon fiber fabric to a crash can bracket.

11. The method of claim 11 further comprising stacking a plurality of layers of the fabric with the fibers in adjacent layers being oriented perpendicularly relative to the adjacent layers.

12. The method of claim 9 wherein the aluminum tube has a front wall, a rear wall, a top wall, and a bottom wall and wherein a bracket for a crash can is secured to the rear wall of the tube and over the layers of fabric.

13. The method of claim 12 wherein the bracket includes an upper clamp and a lower clamp that clamp the layers of fabric to the top wall and the bottom wall, respectively.

14. The method of claim 9 wherein the resin and curing agent are two parts of an epoxy bonding system.

15. The method of claim 9 wherein at least fifteen layers of carbon fiber fabric are wrapped about the bumper beam.

16. The bumper beam of claim 9 wherein between sixteen and twenty layers of carbon fiber fabric are wrapped about the bumper beam.
